(19) United States
(12) Patent Application Publication
(10) Pub. No.: US 2006/0212627 A1
(43) Pub. Date: Sep. 21, 2006

(54) Legacy serial/parallel port device

(76) Inventors: Michael R. Durham, Tomball, TX (US); Louis B. Hobson, Tomball, TX (US); Gregory P. Ziarnik, Houston, TX (US); Stephen J. Higham, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/080,888

(22) Filed: Mar. 15, 2005

(51) Int. Cl. G06F 13/00

(52) U.S. Cl. 710/100

(57) ABSTRACT

Systems, devices, methodologies, and other embodiments associated with serial and parallel ports are described. One example system embodiment includes a device for providing serial and parallel ports in a computer. The example device can include a bracket configured to be secured to an expansion slot of the computer where a serial port and a parallel port are mounted to the bracket. The device can further include a serial port cable having a first end connected to the serial port and a second end including a serial port receptacle. The device can further include a parallel port cable having a first end connected to the parallel port and a second end including a parallel port receptacle. The serial port receptacle and the parallel port receptacle can be configured to be operably connected to a motherboard of the computer.

### BACKGROUND

Computers can be configured to provide a variety of input and output options. For example, input/output connectors can be included on a chassis of a computer to provide connections for a universal serial bus (USB), Ethernet, audio, video, and the like. However, due to smaller sizes of computers, some designs do not include older types of input/output connectors due to space restrictions. These “legacy” types of connectors can include a serial port, a parallel port, a PS/2 mouse port, and/or a keyboard port.

However, many customers desired to have a serial and parallel port, for example, to function with older devices and applications. One option included serial/parallel ports configured as a peripheral component interconnect (PCI) card. The PCI card was inserted into a PCI slot, but then its memory addresses needed to be mapped to Legacy I/O addresses so that older software applications could recognize and function with the parallel and serial ports. This solution, however, caused errors in the basic input/output system (BIOS) and many applications did not function properly.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates one embodiment of a serial/parallel port device.

FIG. 2 illustrates one embodiment showing a serial/parallel port adapter and an example motherboard configuration of a computer.

FIG. 3 illustrates an example configuration of pin connections that can be used in a cable receptacle.

FIG. 4 illustrates an example methodology that can be associated with configuring a computing device to accommodate a serial/parallel port adapter.

FIG. 5 illustrates an example computing device in which example systems and methods illustrated herein can operate.

### DETAILED DESCRIPTION

Example systems, methods, devices, and other embodiments are described herein that relate to communication ports for computer systems. In one example embodiment, a serial/parallel port adapter is connectible to a computer to provide an optional serial port and parallel port. The adapter can be configured to be connected to a motherboard by cables running from the serial port and the parallel port to establish communications between the ports and a super I/O chip on the motherboard. The cables provide flexibility in positioning the serial/parallel port adapter to a vacant input/output expansion slot of the computer. Thus, by communicating directly with the super I/O chip, the serial/parallel port adapter does not need to be connected in a peripheral component interconnect (PCI) slot and thus does not require a PCI interrupt to function with the operating system and/or basic input/output system (BIOS).

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, semiconductor memories, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, a bit or bit stream, or other means that can be received, transmitted and/or detected.

“User”, as used herein, includes but is not limited to one or more persons, software, computers or other devices, or combinations of these.

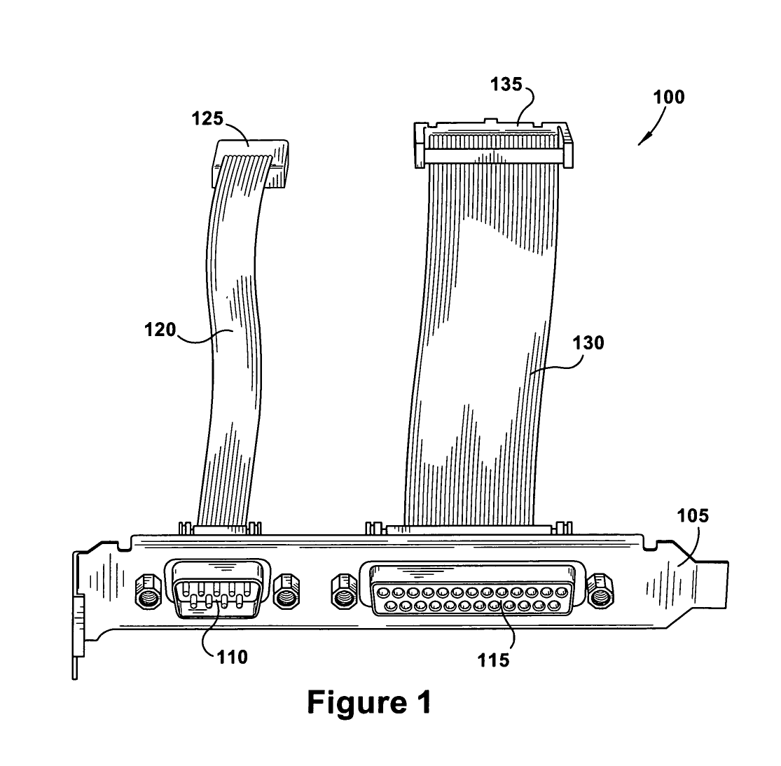

FIG. 1 illustrates one example embodiment of a serial/parallel port device 100 that is configured to provide an optional serial and parallel port in a computer. The port device 100 is configured to be removably attachable to a computer and can be installed at any time when a serial and/or parallel port is desired. For example, the port device 100 can be installed within a computer during manufacture or assembly of the computer or can be installed subsequently by a user. The port device 100 will also be referred to as a serial/parallel port adapter since it is configured to provide features and/or functions that a computer may not originally provide, or at least provide an additional serial and parallel port.

The serial/parallel port device 100 can include, for example, a bracket 105 that includes a serial port 110 and a parallel port 115 mounted thereto. The bracket 105 can be an input/output panel bracket that can be attached to on I/O slot opening on a computer housing. In one embodiment, the serial port 110 can include a 9-pin connector and the parallel port 115 can include a 25-pin connector, but other types of connectors can be used. A serial port cable 120 is connected to the serial port 110 at one end and connected to a serial port receptacle 125 at the other end. Similarly, a parallel port cable 130 is connected at one end to the parallel port 115 and at the other end to a parallel port receptacle 135. In one example, the cables 120, 130 can be ribbon cables. In general, the receptacles 125, 135 can be configured with electrical connectors and can be either male or female.

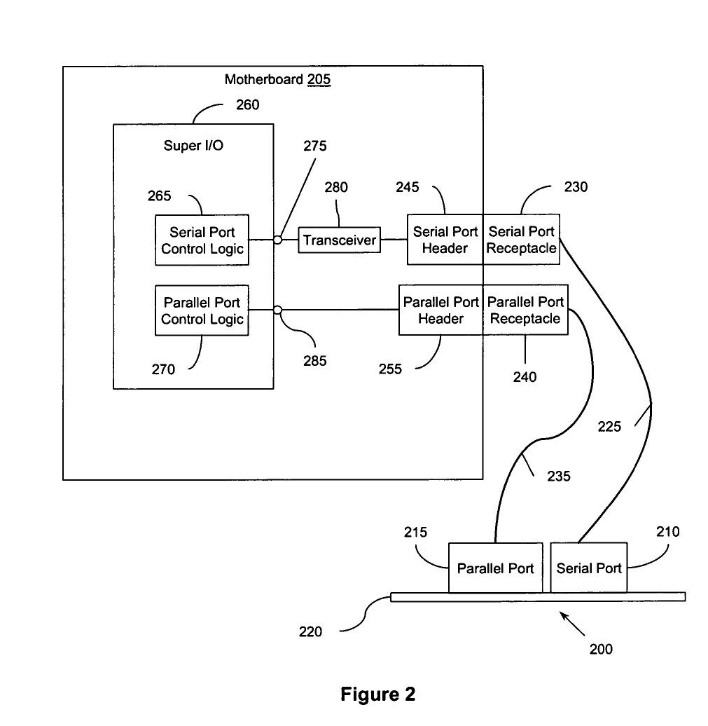

The serial port receptacle 125 and the parallel port receptacle 135 can be configured to be operably connected to a motherboard of a computer so as to provide signal communication between the computer and the serial port 110 and the parallel port 115. It will be appreciated that the motherboard will be configured with an appropriate interface for connecting to the serial port receptacle 125 and the parallel port receptacle 135 and include appropriate control logic to facilitate communications with the serial port 110 and the parallel port 115. One example embodiment will be described with reference to FIG. 2.

With reference to FIG. 2, an example block diagram illustrates one embodiment of a serial/parallel port adapter 200 connected to a motherboard 205 of a computing device. Similar to the port adapter 100 shown in FIG. 1, the serial/parallel port adapter 200 includes a serial port 210 and a parallel port 215 mounted to a bracket 220. The bracket 220 serves to support the serial port 210 and the parallel port 215, and is configured to be removably attachable to an I/O expansion slot on a housing or chassis of a computer. Once attached to the expansion slot, the serial port 210 and the parallel port 215 will be accessible by a user in order to connect serial and/or parallel devices into the ports.

The serial port 210 includes a serial port cable 225 that includes a serial port receptacle 230 connected to the other end of the cable 225. Similarly, the parallel port 215 includes a parallel port cable 235 that has a parallel port receptacle 240 connected at its end. The serial port receptacle 230 and the parallel port receptacle 240 are configured to operably connect and mate with a corresponding connector on the motherboard 205.

For example, the motherboard 205 can include a serial port header 245 configured to operably connect with the serial port receptacle 230. The motherboard 205 can also include a parallel port header 255 configured to operably connect with the parallel port receptacle 240. In one embodiment, the motherboard 205 includes a super I/O chip 260 that is configured to communicate with peripheral devices such as a floppy disk and devices connected through a serial and/or parallel port. As such, the super I/O chip 260 is configured with serial port control logic 265 that controls communication with the serial port 210 and includes a parallel port control logic 270 configured to control communications with the parallel port 215. The super I/O chip 260 is a common integrated circuit and will not be described in great detail.

To configure the super I/O chip 260 to function with the serial/parallel port adapter 200, one or more general purpose input/output (GPIO) pins from the super I/O chip 260 are electrically connected to the serial port header 245 and the parallel port header 255 of the motherboard 205. For example, GPIO pin 275 is selected and operably connected to the serial port header 245 to facilitate communications between the serial port control logic 265 and the serial port header 245. Thus, when the serial port receptacle 230 is connected to the serial port header 245, a communication channel is created so that signals can be transmitted between the serial port control logic 265 and the serial port 210. In another embodiment, a transceiver logic 280 can be connected to the serial port 210 to function as a buffer that level shifts out-going and in-coming data to the proper signal levels.

Referring to the parallel port control logic 270, a GPIO pin 285 can be selected and operably connected to the parallel port header 255 to facilitate communications there between and, thus, communications to and from the parallel port 215. It will be appreciated that the super I/O chip 260 is in data communication with the basic input/output system (BIOS) of the computer. Thus, when the computer is booted and goes through an initialization process, the BIOS will detect the presence of the serial port 210 and parallel port 215 through settings detected by the super I/O chip 260 (e.g. bit values in GPIO registers). Upon successful initialization, the serial port 210 and parallel port 215 will be functional with the operating system, allowing external devices to be connected to the serial port 210 and parallel port 215. Furthermore, since the serial port control logic 265 and the parallel port control logic 270 is configured to operate with serial and parallel ports, I/O addresses do not need to be re-mapped as in the case of a PCI serial/parallel port card. By avoiding address re-mapping, errors can be reduced or eliminated when operating with older software applications that expect the I/O addresses of the serial and parallel ports to be at specific values.

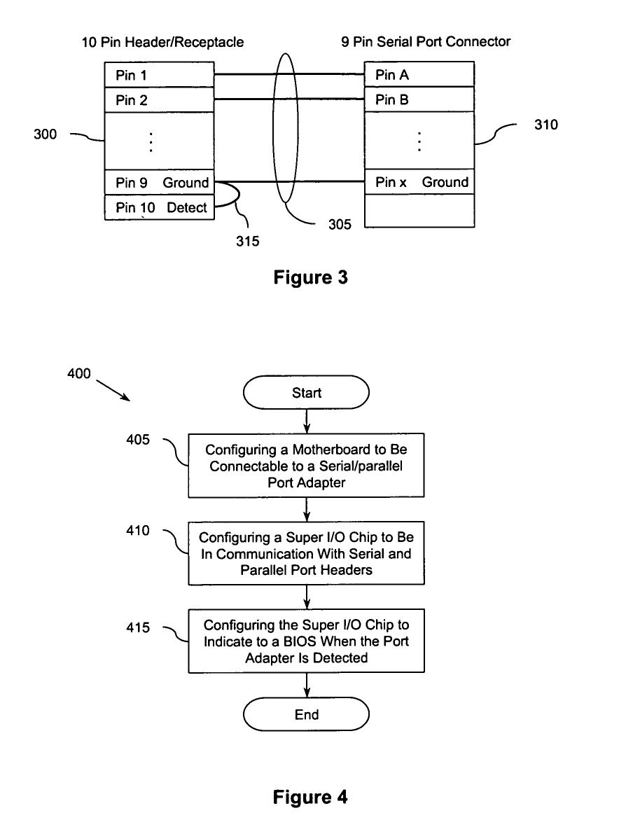

Illustrated in FIG. 3 is one example embodiment of pin connections within a serial port header/receptacle 300 that can facilitate detection of a connected cable. For example, the header/receptacle 300 can be a 10-pin connection between a serial port header on a motherboard and a serial port receptacle on the end of a serial port cable. It will be appreciated that the signals assigned to each pin are not specifically identified since signal-to-pin assignments can vary. Signal lines 305 form the serial cable and are electrically connected to an associated pin in a serial port connector 310 that forms the serial port. Again, since signal and pin assignments can vary, no particular pin assignments are illustrated.

In the example, the serial port connector 310 can be a 9-pin connector that has its ground pin (e.g. pin X) connected to the ground pin of the header/receptacle 300 (e.g. pin 9). The header/receptacle 300 includes a detect pin (e.g. pin 10) that is used by the super I/O chip to determine when the serial port cable is connected to the serial port header on the motherboard. In one embodiment, a loopback connection 315 is created that electrically connects the ground pin to the detect pin in the serial port receptacle to generate a detect signal for the super I/O chip. Of course, the detect signal pin can be connected with other pins if desired and other types of connectors with varying numbers of pins can be used. Likewise, the connections for the parallel port can be similarly configured such as by using a 25-pin parallel port connector and a 26-pin parallel port receptacle that includes a detect pin configured to indicate to the super I/O chip that a parallel port cable has been connected to the motherboard.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

Illustrated in FIG. 4 is an example methodology 400 that can be associated with configuring a computing device to communicate with a serial/parallel port adapter. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device. The diagram of FIG. 4, as well as the other illustrated diagrams, are not intended to limit the implementation of the described examples. Rather, the diagrams illustrate functional information one skilled in the art could use to design/fabricate circuits, generate software, build the port adapter, configure a computer, and the like.

With reference to FIG. 4, the example methodology 400 will be described with reference to a computing device that includes a motherboard having a super I/O chip for communicating with ports. For example, the methodology 400 can include configuring the motherboard within the computing device to be connectable to a serial/parallel port adapter that includes a serial port and a parallel port (Block 405). In one example, the motherboard can be configured to include a serial port header for connecting to a serial port cable from the serial port, and a parallel port header for connecting to a parallel port cable from the parallel port.

Additionally, the super I/O chip that is mounted to the motherboard can be configured to be in communication with the serial port header and the parallel port header (Block 410). The super I/O chip can be further configured to detect whether the serial/parallel port adapter is connected to the motherboard. The super I/O chip can also be configured to indicate to the BIOS of the computing device when the serial/parallel port adapter is connected such that the BIOS can operate with the serial port and the parallel port (Block 415). For example, a general purpose input/output (GPIO) register within the super I/O chip can be configured to set a value when serial/parallel port cable(s) are connected to the motherboard (e.g. one register per cable). Upon initialization of the computing device, the BIOS can read the GPIO register(s) and determine whether the serial/parallel port adapter is present and if so, initialize the serial and parallel ports and make them available to the operating system.

It will be appreciated that the methodology 400 can be implemented in a variety of ways such as an assembly process of a computing device as a machine-implemented process. It may also be implemented as a design process that is performed by computer software used to design the layout of the motherboard and/or signal paths between components of the motherboard. As such, the methodology 400 can be a computer-implemented process. In another embodiment, a computer-readable medium can be configured to provide computer-executable instructions that cause a computer to perform one or more portions of the methodology 400 when executed.

With the serial/parallel port adapter as described above and its equivalent embodiments, a computing device can be configured to include a serial and parallel ports when such ports may not be originally included in the computing device. By using cables to connect the port adapter to the motherboard, the port adapter can be easily positioned in an available expansion slot in the computing device. Furthermore, by processing communications from the serial/parallel port adapter to the super I/O chip, which is configured to process serial and parallel ports, use of a PCI slot can be avoided. By avoiding the use of a PCI slot, remapping of the PCI slot addresses to Legacy serial/parallel port addresses can also be avoided. By avoiding the re-mapping of addresses, communication errors between software applications and the Legacy serial port and parallel ports can be reduced or eliminated.

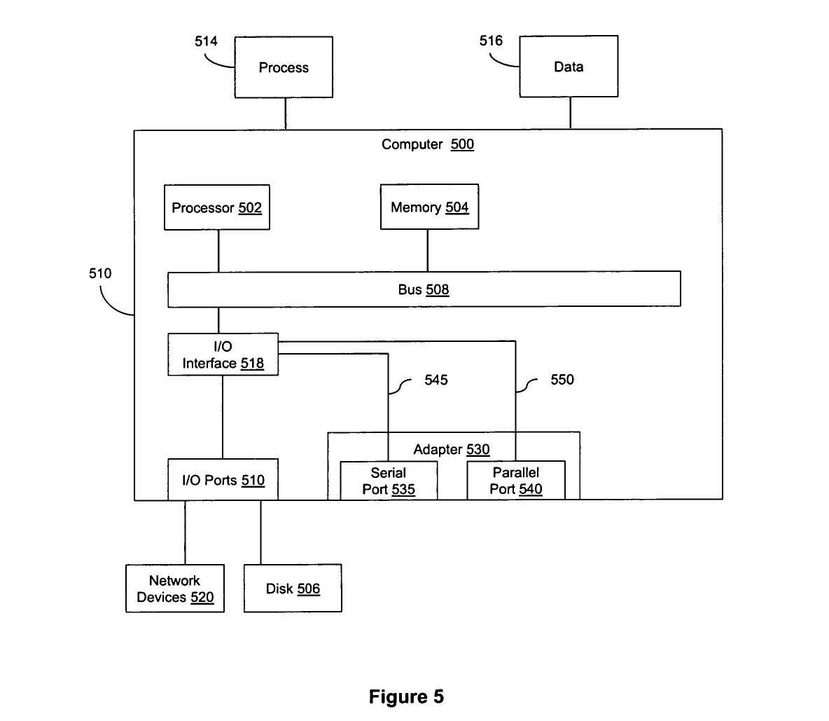

FIG. 5 illustrates an example computing device in which example systems and methods described herein, and equivalents, can operate. The example computing device may be a computer 500 that includes a processor 502, a memory 504, and input/output ports 510 operably connected by a bus 508. The computer 500 can be contained within a housing 510. In one example, the computer 500 may include a serial/parallel port adapter 530 configured to provide a legacy serial port 535 and a parallel port 540. The serial/parallel port adapter 530 can be implemented similar to the serial/parallel port adapter 100 and 200 described in FIGS. 1 and 2, respectively, and/or the other systems and methods described herein.

Generally describing an example configuration of the computer 500, the processor 502 can be a variety of various processors including dual microprocessor and other multi-processor architectures. The memory 504 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 506 may be operably connected to the computer 500 via, for example, an input/output interface (e.g., card, device) 518 and an input/output port 510. The disk 506 can include, but is not limited to, devices like a magnetic disk drive, a solid state disk drive, a floppy disk drive, a tape drive, a Zip drive, a flash memory card, and/or a memory stick. Furthermore, the disk 506 can include optical drives like a CD-ROM, a CD recordable drive (CD-R drive), a CD rewriteable drive (CD-RW drive), and/or a digital video ROM drive (DVD ROM). The memory 504 can store processes 514 and/or data 516, for example. The disk 506 and/or memory 504 can store an operating system that controls and allocates resources of the computer 500.

The bus 508 can be a single internal bus interconnect architecture and/or other bus or mesh architectures. While a single bus is illustrated, it is to be appreciated that computer 500 may communicate with various devices, logics, and peripherals using other busses that are not illustrated (e.g., PCIE, SATA, Infiniband, 1394, USB, Ethernet). The bus 508 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 500 may interact with input/output devices via I/O interfaces 518 and input/output ports 510. The I/O interfaces 518 can include a super I/O chip as described previously that communicates with the serial/parallel port adapter 530 through a serial port cable 545 and a parallel port cable 550. Input/output devices can include, but are not limited to, a keyboard, a microphone, a pointing and selection device, cameras, video cards, displays, disk 506, network devices 520, and the like. The input/output ports 510 can include but are not limited to, serial ports, parallel ports, and USB ports.

The computer 500 can operate in a network environment and thus may be connected to network devices 520 via the i/o devices 518, and/or the i/o ports 510. Through the network devices 520, the computer 500 may interact with a network. Through the network, the computer 500 may be logically connected to remote computers. The networks with which the computer 500 may interact include, but are not limited to, a local area network (LAN), a wide area network (WAN), and other networks. The network devices 520 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 520 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A device for providing serial and parallel ports in a computer, the device comprising:
a bracket configured to be secured to an expansion slot of the computer;
a serial port mounted to the bracket;
a serial port cable having a first end connected to the serial port and a second end including a serial port receptacle;
a parallel port mounted to the bracket;
a parallel port cable having a first end connected to the parallel port and a second end including a parallel port receptacle; and
the serial port receptacle and the parallel port receptacle being configured to be operably connected to a motherboard of the computer and configured to communicate signals with a super I/O chip to provide data communications between the computer and the serial port and the parallel port.

2. The device of claim 1 where the serial port cable and the parallel port cable are ribbon cables.

3. The device of claim 1 where the serial port receptacle includes a plurality of pins and includes a loopback connection that electrically connects two pins to generate a cable detect signal for the super I/O chip.

4. The device of claim 1 where the parallel port receptacle includes a plurality of pins and includes a loopback connection that electrically connects two pins to generate a detect signal for the super I/O chip.

5. The device of claim 1 being a removably attachable device that provides the serial port and the parallel port as optional ports to the computer.

6. A computing device, comprising:
a housing;
a motherboard mounted within the housing;
a super I/O chip mounted to the motherboard and configured to communicate data communications with peripheral devices;
a serial/parallel port adapter being removably connected to the housing to provide an optional serial and parallel port, the serial/parallel port adapter comprising:
a serial port, and a serial port cable connecting the serial port to the motherboard and being in data communication with the super I/O chip; and
a parallel port, and a parallel port cable connecting the parallel port to the motherboard and being in data communication with the super I/O chip.

7. The computing device of claim 6 further including a serial port header formed on the motherboard and being in signal communication with the super I/O chip, the serial port header being a connection interface between the serial port cable and the motherboard.

8. The computing device of claim 7 where the serial port cable includes a receptacle for connecting the serial port cable to the serial port header on the motherboard.

9. The computing device of claim 6 further including a parallel port header formed on the motherboard and being in signal communication with the super I/O chip, the parallel port header being a connection interface between the parallel port cable and the motherboard.

10. The computing device of claim 9 where the parallel port cable includes a receptacle for connecting the parallel port cable to the parallel port header on the motherboard.

11. The computing device of claim 6 where the serial and parallel ports are assigned I/O addresses that are not re-mapped from peripheral component interconnect addresses.

12. The computing device of claim 6 where the serial port and the parallel port are mounted to a bracket that is attached to an expansion slot in the housing.

13. A method of configuring a computing device, the method comprising:
configuring a motherboard within the computing device to be connectable to a serial/parallel port adapter that includes a serial port and a parallel port;
providing the motherboard with a serial port header for connecting to a serial port cable from the serial port, and a parallel port header for connecting to a parallel port cable from the parallel port;
configuring a super I/O chip that is mounted to the motherboard to be in communication with the serial port header and the parallel port header, where the super I/O chip is configured to detect whether the serial/parallel port adapter is connected to the motherboard; and
configuring the super I/O chip to indicate to a BIOS of the computing device when the serial/parallel port adapter is detected such that the BIOS can operate with the serial port and the parallel port.

14. The method of claim 13 further configuring a general purpose input/output pin from the super I/O chip to be in communication with the serial port header.

15. A port adapter, comprising:
means for providing a serial port;
means for providing a parallel port;
means for mounting the serial port and the parallel port to a computer;
means for providing data communication between a motherboard of the computer and the serial port and the parallel port where the motherboard can communicate with the serial port and the parallel port using non-PCI mapped I/O addresses; and
where the port adapter is configured to be removably attachable to the computer to provide the serial port and the parallel port as optional ports.

16. The port adapter of claim 15 being configured to be attachable to an expansion I/O slot in the computer.

17. The port adapter of claim 15 where the means for providing data communication includes a serial cable having a receptacle for connecting to the motherboard and a parallel cable having a receptacle for connecting to the motherboard.

18. The port adapter of claim 15 where the means for providing data communication is configured to communicate signals with a super I/O chip to provide data communications between the computer and the serial port and the parallel port.
